(19) United States
(12) Patent Application Publication
(10) Pub. No.: US 2026/0213999 A1
(43) Pub. Date: Jul. 23, 2026

(54) Determination of Output from Twinned Network Function

(71) Applicant: Telefonaktiebolaget LM Ericsson (publ), Stockholm (SE)

(72) Inventors: Harri Hakala, Turku (FI); Anu Puhakainen, Espoo (FI); Joel Patrick Reijonen, Kirkkonummi (FI)

(21) Appl. No.: 19/143,974

(22) PCT Filed: Dec. 29, 2022
(86) PCT No.: PCT/SE2022/051251

§ 371 Date: Jun. 27, 2025

(51) Int. Cl. H04L 41/0823; H04L 41/0895; H04L 41/5009; H04L 43/20

(52) U.S. Cl. CPC H04L 41/0823; H04L 41/0895; H04L 41/5009; H04L 43/20

(57) ABSTRACT

A first network device (101) in a computer network (100), the first network device being connected to a second network device (102), the second network device possessing capabilities of a network manager function, and the first network device hosts a network function. The first network device operative to create an enclave; and determine, using the enclave, from an output of a twinned network function (105) based on a hosted network function (106), if the output exposes a vulnerability or if the output indicates that the twinned network function has ceased to operate according to operational criteria set for the hosted network function, Disclosed is also the second network device, a third network device, related methods, computer programs and computer program products.

### TECHNICAL FIELD

The invention relates to methods for creation of enclaves and determination of vulnerabilities in or operation of twinned network functions using the enclaves. Corresponding network devices, computer programs and computer program products are also disclosed.

### BACKGROUND

Modern computer networks are changed commonly for the purpose of either enhancing or changing functionality or to improve the security of the networks and the components therein.

Enhancing or changing functionality is typically done by updating the network devices with new or different software. To accomplish this, the network must be typically taken offline or placed in a safe mode to prevent disruptions to the production environment that the network is operating in. This may also be to patch vulnerabilities in the network and its components. This functionality is typically implemented and initiated by a network manager apparatus.

The process used for vulnerability detection & scanning and security gap analysis today consists of a variety of different approaches. One such approach is conducting vulnerability scanning activities by a security team mainly in the server setup and deployment phase to verify the server's initial security posture using a variety of different tools or hiring someone to conduct vulnerability scans.

US 2013/0191919 A1 discloses a standardized vulnerability score which is identified for a particular vulnerability in a plurality of known vulnerabilities, the standardized vulnerability relative other vulnerabilities. A vulnerability detection score is determined that indicates an estimated probability that a particular asset possesses the particular vulnerability, and a vulnerability composite score is determined for the particular asset to the particular vulnerability. The vulnerability composite score is derived from the standardized vulnerability score and the vulnerability detection score. A countermeasure component score is identified that indicates an estimated probability that a countermeasure will mitigate risk associated with the particular vulnerability on the particular asset. A risk metric for the particular asset and the particular vulnerability is determined from the vulnerability composite score and the countermeasure component score. In some instances, aggregate risk scores can be calculated from a plurality of calculated risk metrics.
US 2021/0042423 A1 discloses a security assessment system configured to provide a duplicated environment which duplicates an assessment target system comprising a plurality of physical components.

Another such an approach is performing vulnerability scans on demand when a new critical vulnerability potentially affecting the servers/applications is identified and reported to verify if such vulnerability exists in the server and on a regular basis to comply with various regulations and compliance standards. Such scans are conducted using a variety of different tools or even different human experts.

Typically, such a scan must be conducted in a specific time window in a safe mode to avoid disruption in production environments. An additional approach is to have an embedded security agent that collects information from the network to identify vulnerabilities. Any vulnerabilities detected during these scans also must be rectified by installing security patches typically during a similar specific time window in a safe mode to avoid disruption in production environments. Vulnerabilities must also be determined to be exploitable, and these vulnerabilities must be prioritized. Without testing whether the vulnerabilities are exploitable, it is difficult to prioritize which vulnerabilities to rectify through patches, system redesigns, or other mitigation strategies. These vulnerability mitigations may be simple changes such as turning off a port or major changes such as changing software versions.

The main philosophy in the existing technology used is to develop a process and plan to continuously assess, track and mitigate vulnerabilities and security weaknesses on all servers within a system infrastructure in order to minimize existence of exploitable vulnerabilities in the system. The system also will perform such scans and changes to the network during a downtime in order to avoid disruption or opening new vulnerabilities to the network during operation.

### SUMMARY

An object of the invention is to enable updating of one or more network functions, such as critical, virtual network functions, in such a way to ensure that such updates do not introduce further risk to a computer network.

According to a first aspect of the invention, there is a first network device in a computer network. The first network device is connected to a second network device. The second network device possess capabilities of a network manager function. The first network device hosts a network function. The first network device comprises processor circuitry. The first network device comprises a storage unit. The first network device comprises a storage unit storing instructions which when executed by the processor circuitry causes the network device to become operative. The first network device is operative to create an enclave. The enclave is capable of receiving input information. The information is associated with the computer network. The enclave is capable of transmitting information to the second network device. The first network device is operative to determine if the output exposes a vulnerability. The first network device is operative to determine if the output indicates that the twinned network function has ceased to operate according to operation criteria. The operational criteria set for the hosted network function. The output of a twinned network function is based on a hosted network function. The determination is made by the first network device after using the input information to run the twinned network function. The determination is made by the first network device using the enclave. The first network device is operative to determine, whereby a change is made to the description files. The description files associated with the twinned network function. The change is made if the outputs exposed a vulnerability. The change is made if the twinned network function has ceased to operate according to operation criteria. The operational criteria set for the hosted network function. The first network device is operative to determine, whereby information is sent. The information related to the description files. The information is sent to the second network device. The information is sent to the second network device to update the hosted network function. Hereby is achieved a solution for enabling updating of one or more network functions, such as critical, virtual network functions, in such a way to ensure that such updates do not introduce further risk to a computer network.

In an embodiment of the first aspect, the enclave cause the first network device to become operative to determine, from an output of a group of twinned network functions cloned from a group of hosted network functions after using the input data sent to the group of hosted network functions to run the group of twinned network functions, if the output exposes a vulnerability or the output indicates that the group of twinned network functions have ceased to operate in substantially the same way as the group of hosted network functions whereby a group of network functions comprise a shared description file associated with the group and each network function in the group comprises a description file associated with the network function.

In an embodiment of the first aspect, the enclave causes the first network device to become operative to initiate the creation of a twinned network function in the enclave whereby the twinned network function is replicated from a hosted network function.

In an embodiment of the first aspect, the enclave causes the first network device to become operative to receive a first information, the first information indicative of the change to be made to description files from network functions and persons.

In an embodiment of the first aspect, the operational criterion is based on a performance metric of the hosted network function a quantitative requirement of a service level agreement; a measurement requirement of a service level agreement; and/or a performance requirement of other network functions or devices.

In an embodiment of the first aspect, the enclave causes the first network device to become operative to change the twinned network function according to a first information and in response to the determination.

In an embodiment of the first aspect, wherein a change to the descriptor files of the twinned network function is made by a person, the enclave, and/or an external device.

In an embodiment of the first aspect, wherein the enclave is only capable of receiving information from hosted network functions; groups of hosted network functions; external computer network; and/or the second network device.

In an embodiment of the first aspect, wherein the enclave is only capable of sending information toward a second network device.

In an embodiment of the first aspect, wherein the processor circuitry causing the network device to be operative to create and/run the enclave is separated from another processor circuitry of the network device.

In an embodiment of the first aspect, wherein the storage unit is encrypted and separate from other storage of the network device, the storage unit storing instructions which when executed by the processor circuitry causes the network device to become operative to create and/or run the enclave.

In an embodiment of the first aspect, the enclave causes the first network device to become operative to receive real time input data associated with the computer network and/or receive previously stored input data associated with the computer network.

In an embodiment of the first aspect, the enclave causes the first network device to become operative to sending second information to the second network device, the second information related to descriptor files of a twinned network function.

In an embodiment of the first aspect, the enclave causes the first network device to become operative to change the description files of the twinned network functions before running the twinned network functions copied from one or more hosted network functions.

In an embodiment of the first aspect, the enclave causes the first network device to become operative to determine if the changed description files create an exposed vulnerability

In an embodiment of the first aspect, the enclave causes the first network device to become operative to determine if the changed description files create an exposed vulnerability in the network device, the determining done by conducting a vulnerability scan of one of the description files; the twinned network functions; or the output of the twinned network functions.

In an embodiment of the first aspect, the enclave causes the first network device to become operative to determine if the changed descriptor files cause a twinned network function to cease operating according to operational criteria.

In an embodiment of the first aspect, the first network device operative to terminate the enclave and/or release computational resources associated with the enclave.

According to a second aspect of the invention, there is a second network device in a computer network. The second network device is connected to a first network device. The first network device is adapted to a network function. The second network device comprises processor circuitry. The second network device comprises a storage unit. The second network device comprises a storage unit storing instructions which when executed by the processor circuitry causes the network device to become operative. The second network device is operative to request the creation of an enclave. The second network device is operative to request, of a first network device, the creation of an enclave. The enclave in the first network device. The second network device is operative to initiate the creation of a twinned network function. The twinned network function within the enclave. The enclave in the first network device. The twinned network function based on a hosted network function. The hosted network function in the computer network. The second network device is operative to send a first 20 information. The first information indicative of a change. The first information indicative of a change to description files. The description files associated with the twinned network function. The second network device is operative to send a third information. The second network device is operative to send a third information toward the hosted network function. The hosted network function associated with the twinned network function. The third information indicative of the description files. The description files being of the twinned network function. Hereby is achieved a solution enabling an improvement of security and performance of network management.

In an embodiment of the second aspect, the twinned network function is one of a set of twinned network functions created based on the hosted network function.

In an embodiment of the second aspect, the second network function is operative to receive different sets of second information associated with different twinned network functions in the set of twinned network functions.

In an embodiment of the second aspect, the second network function is operative to determine the third information associated with one of a set of twinned network functions from the different sets of second information associated with different twinned network functions in the set of twinned network functions.

In an embodiment of the second aspect, the determining the third information based on: the description files with the fewest changes compared to the description files associated with the hosted network function; the description files that result in the best performance of the twinned network function or the best performance of the network device or the best performance of the communications network; the description files that cause the twinned network function to operate according to or exceeding the operational criteria of the hosted network function; the description files that contain the fewest number of detected vulnerabilities; and/or the description files received first by the second network device.

In an embodiment of the second aspect, the second network function is operative to initiate the creation of a twinned network function copied from a hosted network function.

In an embodiment of the second aspect, the second network function is operative to initiate the creation of a group of twinned network functions based on a group of hosted network function, the creation taking place within the enclave of the first network device. The second network function is operative to send a first information, the first information indicative of a change to description files associated with the group of twinned network functions. The second network function is operative to send a third information towards the group of hosted network functions associated with the group of twinned network functions, the third information indicative of description files.

In an embodiment of the second aspect, the second network function is operative to receive instructions indicative of changes in description files from network functions and persons.

In an embodiment of the second aspect, the second network function is operative to initiate in the first network function terminating the enclave and/or releasing any computation resources associated with the enclave.

According to a third aspect of the invention, there is a first network device in a computer network. The third network device comprising a network manager function. The third network device hosts a network function. The third network device comprises processor circuitry. The third network device comprises a storage unit. The third network device comprises a storage unit storing instructions which when executed by the processor circuitry causes the network device to become operative. The third network device is operative to create an enclave. The enclave is capable of receiving input information. The information is associated with the computer network. The enclave is capable of sending information out of the enclave. The enclave is capable of sending information to the network management function. The third network device is operative to determine if the output exposes a vulnerability. The third network device is operative to determine if the output indicates that the twinned network function has ceased to operate according to operation criteria. The operational criteria set for the hosted network function. The output of a twinned network function is based on a hosted network function. The determination is made by the third network device after using the input information to run the twinned network function. The determination is made by the third network device using the enclave. The third network device is operative to determine, whereby a change is made to the description files. The description files associated with the twinned network function. The change is made if the outputs exposed a vulnerability. The change is made if the twinned network function has ceased to operate according to operation criteria. The operational criteria set for the hosted network function. The third network device is operative to determine, whereby information is sent. The information related to the description files. The information is sent to the network management function. The information is sent to the network management function to update the hosted network function. Hereby is achieved a solution for enabling updating of one or more network functions, such as critical, virtual network functions, in such a way to ensure that such updates do not introduce further risk to a computer network.

In an embodiment of the third aspect, the third network function is operative to request of the network device, the request indicative of the creation of an enclave. The third network function is operative to initiate the creation of a twinned network function based on a hosted network function within the enclave of the network device. The third network function is operative to send a first information, the first information indicative of a change to description files associated with the twinned network function. The third network function is operative to receive a second information, the second information related to the description files of the twinned network function. The third network function is operative to send at third information towards the hosted network function associated with the twinned network function, the third information indicative of description files.

In an embodiment of the third aspect, the third network function is operative to perform the operations of the first network device according to the embodiments of the first aspect whereby the second network device is replaced by the network manager function.

In an embodiment of the third aspect, the third network function is operative to perform the operations of the second network device according to the embodiments of the second aspect whereby the first network device is replaced by the third network device.

In a fourth aspect of the invention, there is provided a method performed by a first network device. The first network device is connected to a second network device. The second network device possess capabilities of a network manager function. The first network device hosts a network function. The method comprises creating an enclave. The enclave is capable of receiving input information. The information is associated with the computer network. The enclave is capable of transmitting information to the second network device. The method comprises determining if the output exposes a vulnerability. The method comprises determining if the output indicates that the twinned network function has ceased to operate according to operation criteria. The operational criteria set for the hosted network function. The output of a twinned network function is based on a hosted network function. The determination is made by the first network device after using the input information to run the twinned network function. The determination is made by the first network device using the enclave. The method comprises determining, whereby a change is made to the description files. The description files associated with the twinned network function. The change is made if the outputs exposed a vulnerability. The change is made if the twinned network function has ceased to operate according to operation criteria. The operational criteria set for the hosted network function. The method comprises determining, whereby information is sent. The information related to the description files. The information is sent to the second network device. The information is sent to the second network device to update the hosted network function.

In an embodiment of the fourth aspect, there is provided a method comprising the operations performed by one or a combination of embodiments of the first aspect.

In a fifth aspect of the invention, there is provided a method performed by a second network device. The second network device is connected to a first network device. The first network device is adapted to a network function. The method comprises requesting the creation of an enclave. The method comprises requesting, of a first network device, the creation of an enclave. The enclave in the first network device. The method comprises initiating the creation of a twinned network function. The twinned network function within the enclave. The enclave in the first network device. The twinned network function based on a hosted network function. The hosted network function in the computer network. The method comprises sending a first information. The first information indicative of a change. The first information indicative of a change to description files. The description files associated with the twinned network function. The method comprises sending a third information. The method comprises sending a third information toward the hosted network function. The hosted network function associated with the twinned network function. The third information indicative of the description files. The description files being of the twinned network function.

In an embodiment of the fifth aspect, there is provided a method comprising the operations performed by one or a combination of embodiments of the second aspect.

In a sixth aspect of the invention of, there is provided a method performed by a third network device. The third network device comprising a network manager function. The third network device hosts a network function. The method comprises creating an enclave. The enclave is capable of receiving input information. The information is associated with the computer network. The enclave is capable of sending information out of the enclave. The enclave is capable of sending information to the network management function. The method comprises determining if the output exposes a vulnerability. The method comprises determining if the output indicates that the twinned network function has ceased to operate according to operation criteria. The operational criteria set for the hosted network function. The output of a twinned network function is based on a hosted network function. The determination is made by the third network device after using the input information to run the twinned network function. The determination is made by the third network device using the enclave. The method comprises determining, whereby a change is made to the description files. The description files associated with the twinned network function. The change is made if the outputs exposed a vulnerability. The change is made if the twinned network function has ceased to operate according to operation criteria. The operational criteria set for the hosted network function. The method comprises determining, whereby information is sent. The information related to the description files. The information is sent to the network management function. The information is sent to the network management function to update the hosted network function.

In an embodiment of the sixth aspect, there is provided a method comprising the operations performed by one or a combination of embodiments of the third aspect.

According to a seventh aspect of the invention, a computer program is provided. The computer program comprises computer readable instructions which is run on processing circuitry of a network device. The computer readable instructions cause the network device to perform the method according to the first aspect, including any of the embodiments of the first aspect.

According to an eighth aspect of the invention, a computer program is provided. The computer program comprises computer readable instructions which is run on processing circuitry of a network device. The computer readable instructions cause the network device to perform the method according to the second aspect, including any of the embodiments of the second aspect.

According to a ninth aspect of the invention, a computer program is provided. The computer program comprises computer readable instructions which is run on processing circuitry of a network device. The computer readable instructions cause the network device to perform the method according to the third aspect, including any of the embodiments of the third aspect.

According to tenth aspect of the invention, a computer program product is provided. The computer program product comprises a computer program according to the first aspect of the invention. The computer program product comprises a computer readable storage medium on which the computer program is stored.

According to eleventh aspect of the invention, a computer program product is provided. The computer program product comprises a computer program according to the first aspect of the invention. The computer program product comprises a computer readable storage medium on which the computer program is stored.

According to eleventh aspect of the invention, a computer program product is provided. The computer program product comprises a computer program according to the first aspect of the invention. The computer program product comprises a computer readable storage medium on which the computer program is stored.

### BRIEF DESCRIPTION OF DRAWING

The accompanying drawings, which are incorporated herein and form part of the specification, illustrate various embodiments.

FIG. 1 is a diagram showing functional units of a network according to an embodiment.

FIGS. 2a-2c illustrate a flow chart of a process according to an embodiment.

FIG. 3 is a flow chart illustrating a process according to an embodiment of the first network device.

FIG. 4 is a flow chart illustrating a process according to an embodiment of the second network device.

FIG. 5 is a diagram showing functional units of a network device according to an embodiment.

FIG. 6 is a diagram showing functional units of a network according to an embodiment.

FIGS. 7a-7c. illustrate a flow chart of a process according to an embodiment.

FIG. 8. is a flow chart illustrating a process according to an embodiment of the first network device.

FIG. 9. is a flow chart illustrating a process according to an embodiment of the second network device.

FIG. 10. is a diagram showing functional units of a network according to an embodiment.

FIGS. 11a-11c illustrate a flow chart of a process according to an embodiment of the third network device.

FIG. 12. is a diagram showing functional units of a first network device according to an embodiment;

FIG. 13. Is a diagram showing functional modules of a first network device according to an embodiment;

FIG. 14. is a diagram showing functional units of a second network device according to an embodiment;

FIG. 15. Is a diagram showing functional modules of a second network device according to an embodiment;

FIG. 16. is a diagram showing functional units of a third network device according to an embodiment;

FIG. 17. Is a diagram showing functional modules of a third network device according to an embodiment; and

FIG. 18. shows one example of a computer program product comprising computer readable means according to an embodiment

### DETAILED DESCRIPTION

The invention will now be described more fully herein with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

The invention as described in the following embodiments enables updating of one or more network functions, such as critical, virtual network functions, in such a way to ensure that such updates do not introduce further risk to a computer network, hereinafter sometimes called “the network”. Additionally, the invention enables updates to improve performance and efficiency of virtual network functions in such a way to ensure that such updates do not introduce unforeseen vulnerabilities to the network. Both benefits are possible due to the ability of the invention to evaluate these virtual network functions in a twinned environment through a novel and inventive feedback loop where the first network device is able to evaluate any changes to the system in real time. Additionally, the invention allows for the quick updating of one or more hosted network functions whereby the network operator can remain confident in continued functionality due to the evaluations of the feedback loop. Normally, such updating would before the implementation of the invention require the virtual network function and network, or parts of the network, it is a part of, that is to be updated, to be taken offline for significant amounts of time to run similar checks on the virtual network function to ensure secure and reliable functionality. The invention also allows for energy savings in the network as changes designed to boost efficiency that might be considered too risky to implement in the network can be evaluated using real time data flows separate from the network with no risk to the network. This invention has the potential to significantly improve the current state of the art of real time network management both in terms of security and performance.

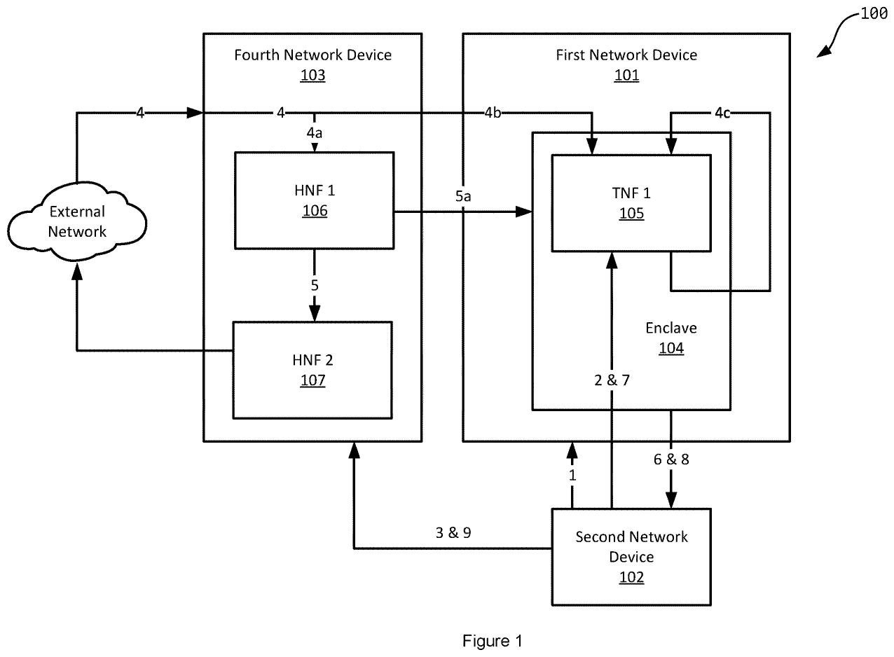

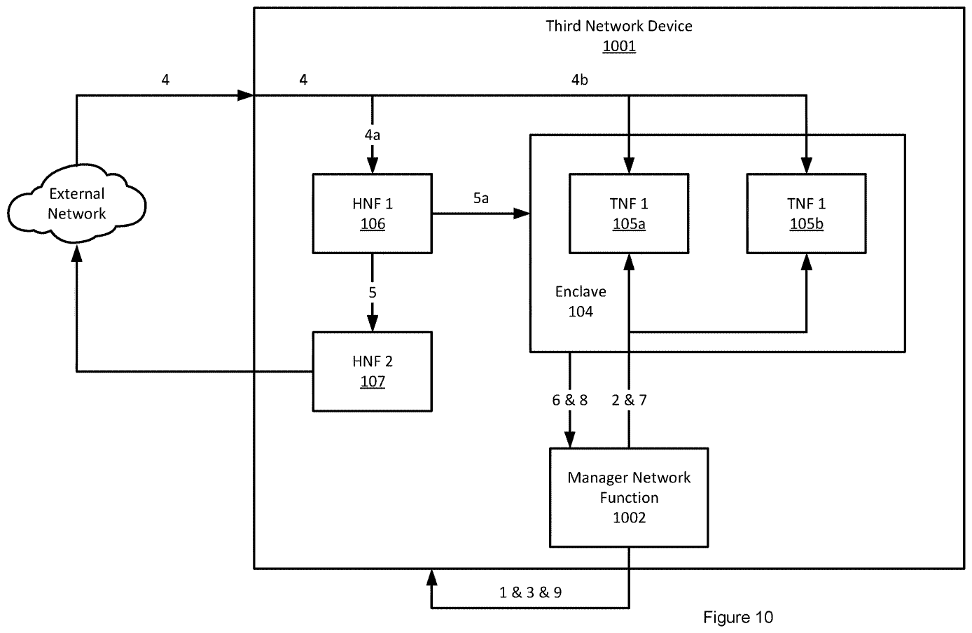

FIG. 1 schematically illustrates a computer network 100 of an embodiment of the current disclosure where a first network device 101 comprises an enclave 104 comprising a twinned network function 105 associated to a hosted network device 106 in a fourth network device 103. A second network device 102 that comprises at least the functionality of a network manager is here connected to both the first network device 101 and the fourth network device 103. Lines with arrows and numbers indicate information flows from one module to another. A third network device 1001 (see FIG. 10) will be disclosed further down.

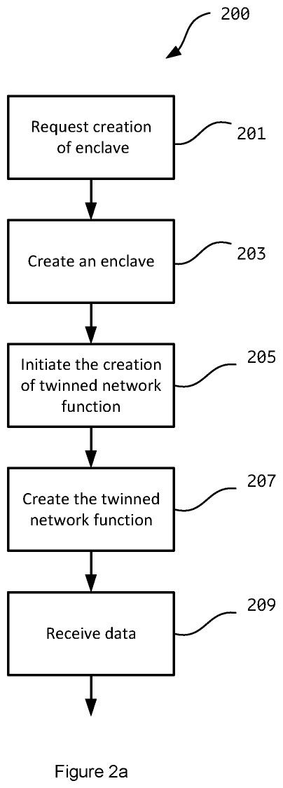

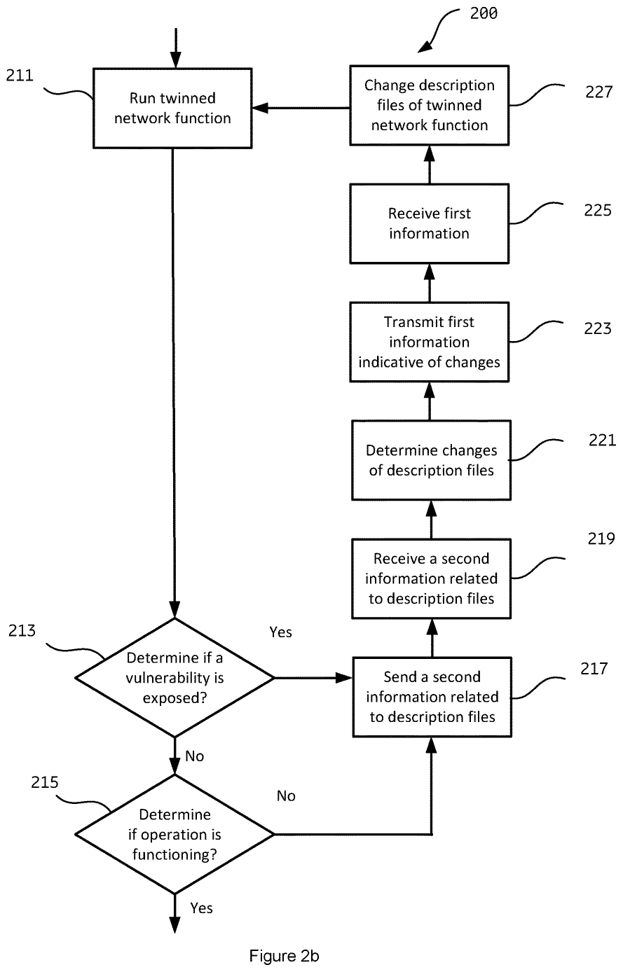

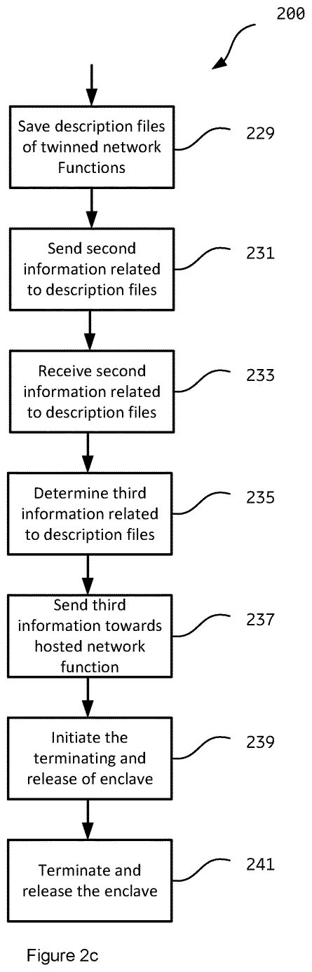

FIG. 2 schematically illustrates a method enabled by the embodiment of FIG. 1, where the enclave comprises a single twinned network function. In a first step 201 indicated by the data flow labeled number one in FIG. 1, the second network device 102 requests the first network device to allocate computer resources to the creation of an enclave. In other words, by requesting the allocation of computer resources, the second network device 102 requests the first network device to create an enclave. In a second step 203, the first network device 101 creates the enclave. The enclave is capable of receiving input data associated with the computer network 100 and transmitting data to the second network device. The enclave is located in a protected storage medium and run-on processing circuitry separate from other hosted network functions running on the first network device or anywhere else in the computer network. Once allocated, the second network device in a third step 205 indicated by the data flow numbered two in FIG. 1, initiates the creation of a twinned network function within the enclave of the first network device by, in one embodiment, instructing the first network device to copy and initialize the twinned network function, the twinned network function based on one of the hosted network functions in the computer network. In a fourth step 207, the first network device then creates the twinned network function based on one of the hosted network functions in the computer network, which in FIG. 1 is illustrated as the hosted network function 106 in the fourth network device 103.

In the current embodiment, the hosted network function is running in a docker container with the descriptor file from the description files. An example of the descriptor file is shown below:
FROM python: 3.6-slim
WORKDIR/usr/src/app
RUN pip install pandas
RUN apt-get update && apt-get install-y nano
CMD [“python”, “./app.py”]

The descriptor file is used to initialize one or more network functions in the network device both inside the enclave and outside the enclave. Upon receiving the instructions from the second network device, the first network device initializes the network function according to the descriptor file in the enclave. This forms the twinned network function.

In a fifth step 209 indicated by data flows 3 and 4, the first network device replicates the input information being used by the hosted network function, which in the current embodiment is a result of the second network device indicating to the first network device to replicate input information. The first network function receives the input information into the enclave, toward the twinned network function. In some embodiments, the input information may be replicated input information that was or is sent to the hosted network function, wherein the input information has been manipulated to add, subtract, or change information in the replicated input information used by the hosted network function. The input information should be still useable or compatible with the hosted network function. An example of this may be that input information is filtered to remove data extraneous or irrelevant to the purpose of the hosted network function and therefore the twinned network function so that the input information is smaller in size.

In a sixth step 211, the first network function uses the input information to run the twinned network function. In the current embodiment, the first network function does this by having the enclave take in the replicated input data flow, labeled as 4b in FIG. 1, and the twinned network function begin to process it according to the description file or files. The twinned network function may also take in the outputted information from itself as an input information such as indicated by data flow 4c in FIG. 1.

The first network device, in a seventh step 213, will then determine, using the enclave, from an output of the twinned network function if the output exposes a vulnerability. This may be done with the analysis of the output information from the twinned network function and thereby determining whether there are any exposed vulnerabilities. The first network device will also, in an eighth step 215, determine if the output indicates that the twinned network function has ceased to operate according to one or more operation criteria set for the hosted network function. This analysis may be augmented by also taking a data flow, labelled as 5a in FIG. 1, which is a copy of the output of the hosted network function, shown as data flow 5 in FIG. 1 sent to a second hosted network function 107, and comparing the copy 5a of the data flow 5 against the output information from TNF1. The order of the seventh and eighth steps may easily be reversed, whereby step 213 may be performed after step 215. In certain embodiments, either step 213 or step 215 may be omitted from the method 200.

The one or more operational criteria may be based on performance metrics of the hosted network functions, one or more quantitative requirements of a service level agreement, one or more measurement requirements of a service level agreement, one or more performance requirements of other network functions or devices, and/or any similar criterion related to the operation of the hosted network function, twinned network function, the network, or devices connected to the network. These performance metrics, performance requirements and quantitative requirements may measure computational resource usage, reliability of the network function's operation, the security of the network function, the computational speed of the network function, the network functions efficiency, or other network measurement metrics used in service level agreements. A measurement requirement is defined as an ability to measure these performance metrics, performance requirements, and/or quantitative requirements. Some quantitative requirements may also be referred to as service level agreement key performance indicators, KPIs. KPIs may also measure latency and service availability of the network in relation to the network function. The twined network function may also be determined whether it performs according to operational criteria of other network functions or devices. Such devices may interact with the hosted network function.

In an embodiment, if the results of the analysis have determined that there are no exposed vulnerabilities and if the twinned network function operates according to operation criteria set for the hosted network device, the descriptor file is saved as a ‘golden’ security configuration of the descriptor file. However, in the current embodiment, the analysis of the output data and the descriptor file will reveal an old version of the python codebase that the twinned network device is running.

In a ninth step 217 indicated by data flow number 6 of FIG. 1, the first network device sends a second information to the second network device, the second information related to the description files of the twinned network function. The second information may comprise the description files of the twinned network functions, information related to exposed vulnerabilities, information related to the operation of the twinned network function, the operational criterion, information related to the twinned network function ceasing to operate according to the operational criterion. In a tenth step 219, the second network device will receive the second information related to the description files of the twinned network function.

In an eleventh step 221 the second network device will determine changes to be made to the description files. These changes may be determined by the network device, a different network device or a person. The changes may be made to rectify an exposed vulnerability or change the operation of the twinned network function to operate closer to the operational criteria set for the hosted network function.

In a twelfth step 223, the second network device sends, as indicated by data flow 7 of FIG. 1, a first information to the first network device, the first information indicative of changes to the description files associated with the twinned network function. The first information may comprise individual changes to the description files, new description files comprising the changes, or some other indication of changes to the description files. In the current embodiment this change is to update from python 3.6 to python 3.8. In a thirteenth step 225, the first network device receives the first information from the second network device.

In a fourteenth step 227, the first network device will use the first information sent from the second network device associated with changes to the description files to then update the description files of the twinned network function.

After the change is made to the description files, the first network device returns to step six and proceed through to step eight. If the analysis from the repeated steps seven and eight determines that there are no exposed vulnerabilities and that the twinned network function operates according to operational criteria set for the hosted network function, the first network device may, in a fifteenth step 229 (see FIG. 2c), save the description files of the twinned network function. These description files may be considered to the be a ‘golden configuration’ of the twinned network function.

The first network device will, in a sixteenth step 231, send, as indicated by data flow 8, the second information to the second network function, the second information related to the description files of the twinned network function. In a seventeenth step 233, the second network function will receive the second information from the first network device. The second information may be, the new description files saved by the first network device, as the description files related to the latest version of the twinned network function. The second information may be an affirmation that the original descriptor files copied from the hosted network functions have no determined exposed vulnerabilities and operate according to the operational criteria and that no changes are necessary. The second information may be the information associated with the changes made to the description files in one or more iterations of steps 211 through 227. In this embodiment however, the installed package, Pandas, has a dependency to the NumPy library which also requires an update to the newest version of the NumPy library in order for the twinned network function to work with the update to python 3.8. Therefore, when the first network device proceeds with steps six through eight, instead of a vulnerability being detected as in the first iteration, the first network device will determine that the twinned network function no longer functions due to the dependencies failing. This will lead to a repeat of steps nine through fourteen where a change is made in the descriptor files where the newest version of the NumPy library is installed and steps six through eight being conducted again. From there the first network device proceeds with steps six through eight where the first network device determines that exposed vulnerabilities have been found and the network function performs in the same way as the hosted network function and therefore move to steps fifteen and sixteen. In an optional eighteenth step 235, the second network device, will determine a third information, the third information indicative of the description files of the twinned network function. The third information is based on the second information and may be new description files based on the second information, an affirmation that the original descriptor files copied from the hosted network function have no determined exposed vulnerabilities and operate according to the operational criteria and that no changes are necessary or may be information associated with changes made to the description files.

In a nineteenth step 237 indicated by data flow number 9 in FIG. 1, the second network device will send a third information towards the hosted network functions associated with the twinned network function. The third information is indicative of description files and may comprise the updated descriptor file. The hosted network functions 106 and 107, in the present embodiment, are in the fourth network device. The third information or the second network device may then initiate, in the fourth network device, the reinitialization of the hosted network function with the updated description files.

In an optional twentieth step 239, the second network device then initiates the termination of the enclave and/or release of the computational resources associated with the enclave. This can be done to possibly save the network device computational resources for use by other network functions such as the hosted network functions in the network device. In an optional twenty-first step 241, the first network device then terminates the enclave and/or releases the computational resources associated with the enclave.

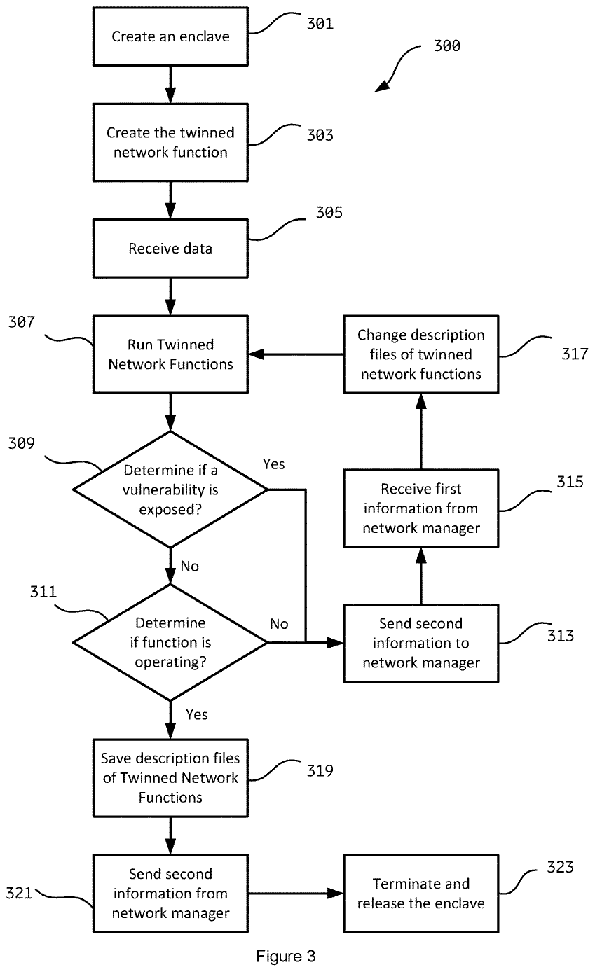

FIG. 3 schematically illustrates a method 300 enabled by the same embodiment as in FIGS. 1 and 2, the method 300 performed by the first network device. The steps of method 300 share common steps as those performed by the first network function in method 200 of FIGS. 1 and 2.

In a first step 301, the first network device creates the enclave, the enclave capable of receiving input data associated with the computer network and transmitting data to the second network device.

In a second step 303, the first network device creates and initializes the twinned network function based on one of the hosted network functions in the computer network. The twinned network function will in this embodiment run in a docker container with description files from the hosted network function but may in alternative exemplary embodiments have been implemented using Buildah, Containerd, Linux Daemon (LXD), Podman, Vagrant, ZeroVM, RUNC, Rkt, Microsoft Azure Container Registry, Kaniko, or BuildKit. In a third step 305, the first network device replicates the input information being used by the hosted network function. The input information may be replicated input information that was or is sent to the hosted network function, wherein the input information has been manipulated to add, subtract, or change information in the replicated input information used by the hosted network function. The input information should be still useable by or compatible with the hosted network function.

In a fourth step 307, the first network function uses the input information to run the twinned network function, the twinned network function residing inside the enclave. In some embodiments, the twinned network function may also take in the outputted information from itself as an input information. In a fifth step 309, the first network function will then determine, using the enclave, from an output of the twinned network function if the output exposes a vulnerability. This may be done with the analysis of the output information from the twinned network function and thereby determining whether there are any exposed vulnerabilities. The first network device will also, in a sixth step 311, determine if the output indicates that the twinned network function has ceased to operate according to one or more operation criteria set for the hosted network function.

In a version of this embodiment, if the results of the analysis have determined that there is no exposed vulnerability and if the twinned network function operates according to the operation criteria set for the hosted network device, the first network device proceeds to a step ten 319 (see below). In the current embodiment, the analysis of the output data and the description files reveal an exposed vulnerability. Due to the exposed vulnerability, the first network device will proceed to a step seven 313.

In the seventh step 313, the first network device will send a second information to the network manager, the second information related to the description files of the twinned network files. In an eighth step 315 following upon the seventh step 313, the first network device will receive a first information from the network manager, the first information indicative of changes to the description files associated with the twinned network function. Using the first information from the network manager, the first network device will use the first information associated with changes to the description files to then update the description files of the twinned network function. In a ninth step 317 following after the eighth step 315, the first network device will use the first information sent from the second network device associated with changes to the description files to then update the description files of the twinned network function.

After the change is made to the description files, the first network device returns to step four 307 and proceeds through to step six 311. If the analysis from the repeated steps four through six determines that there are no exposed vulnerabilities and that the twinned network function operates according to operational criteria set for the hosted network function, the first network device may, in the tenth step 319 save the description files of the twinned network functions. The first network device will, in an eleventh step 321, send the second information to the network manager, the second information related to the description files of the twinned network function. Finally in an optional twelfth step 323, the first network function terminates the enclave and/or release the computational resources associated with the enclave.

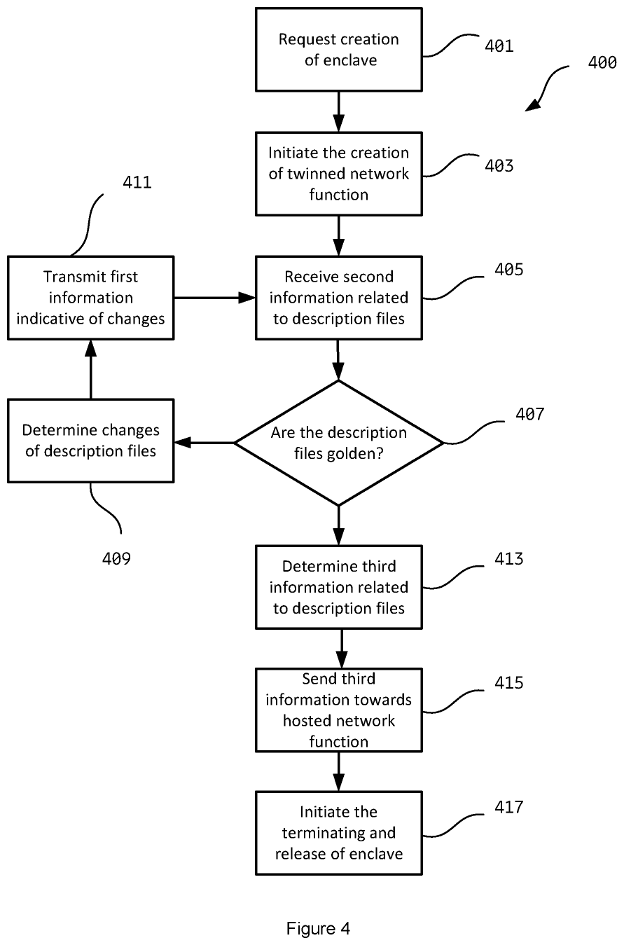

FIG. 4 schematically illustrates a method 400 related to the same embodiment as in FIGS. 1 and 2, the method 400 performed by the second network device. The steps of the method 400 share common steps as those performed by the second network function in method 200, apart from step 307, which is implicit in method 200.

In a first step 401, the second network device 102 requests the first network device to allocate computer resources to the creation of an enclave, i.e. requesting the first network device to request creation of an enclave. In a second step 403, the second network device initiates the creation of a twinned network function within the enclave of the first network device, by, in an embodiment, instructing the first network device to copy and initialize the twinned network function, the twinned network function based on one of the hosted network functions in the computer network. As a part of this initialization, the second network device may also indicate to the first network device to replicate the input information. The second network device may also indicate to a fourth network device hosting the hosted network device to send the input information to the first network device.

In a third step 405, the second network device receives, from the first network device, the second information related to description files of the twinned network function. The second information also contains an indication if the twinned network functions are satisfactory, which in the current embodiment, means that the twinned network function did not have an exposed vulnerability and was operating according to one or more operation criteria set for the hosted network function.

In a fourth step 407, the second network device determines if the twinned network function and/or the description files are satisfactory based on the indication provided from the second information.

If not satisfactory, the second network device proceeds with a fifth step 409, where the second network device will determine changes to be made to the description files. In a sixth step 411, the second network device will then transmit a first information to the first network device, the first information indicative of changes to the description files associated with the twinned network function. The method 400 will then return to the third step 405 with a new second information and proceed to the fourth step 407.

If in the fourth step, 407 the indication was satisfactory, the second network device, in a seventh step 413, will determine a third information, the third information indicative of the description files of the twinned network function. Then in an eighth step 415, the second network device will send a third information towards the hosted network functions associated with the twinned network function. The third information or the second network device may then initiate, in the fourth network device, the reinitialization of the hosted network function with the updated description files.

In an optional ninth step 417, the second network device, then initiates the termination of the enclave in the first network device and/or release of the computational resources associated with the enclave in the first network device.

In some embodiments, the fourth network device may comprise multiple hosted network functions organized in a service and multiple services organized in an infrastructure as a code implementation or any combination of network functions, services and infrastructure as code or any similar network organizational structure that may be virtualized.

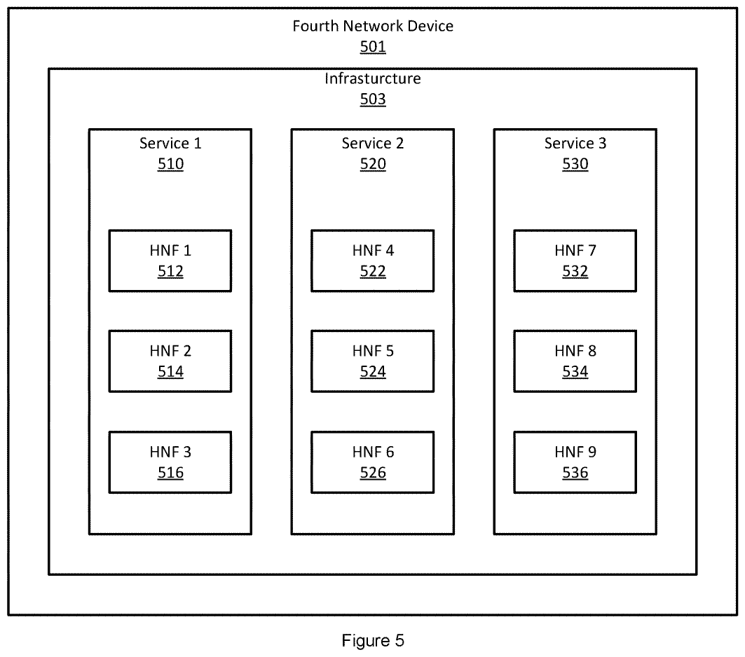

FIG. 5 illustrates an example of the fourth network device 103 comprising an infrastructure as code implementation 503. The infrastructure comprises multiple services 510, 520, 530, respectively, whereby each service comprises multiple network functions such as service 1 comprises HNF 1,2, and 3 (106, 107 516). An illustrated service 2, 520 comprises hosted network functions 4, 5 and 6 (522, 523 and 524, respectively). Illustrates Service 3, 530, comprises hosted network functions 7, 8, and 9. Each HNF comprises at least a descriptor file and possibly an image file or similar. Each service also comprises at least a descriptor file and an image file or similar.

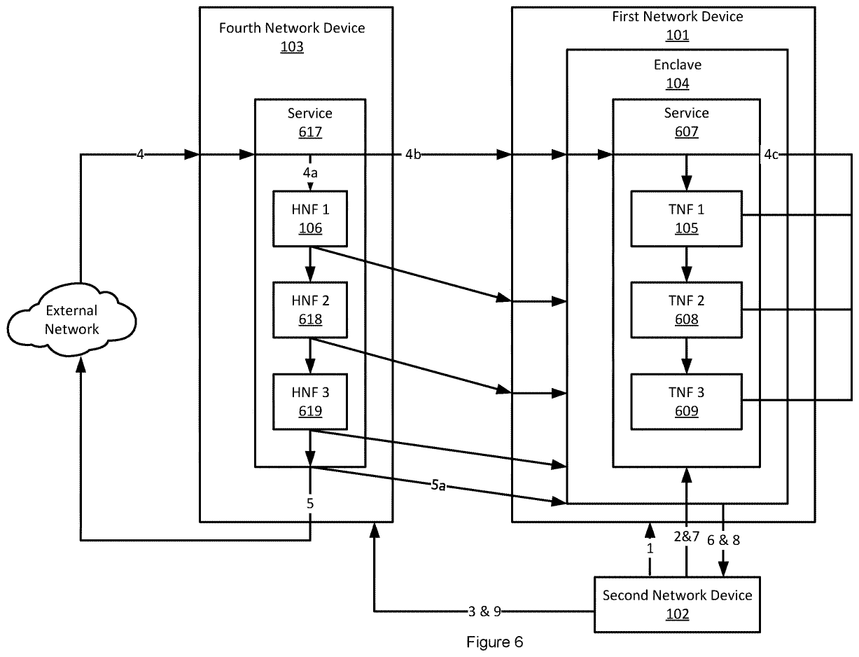

FIG. 6 schematically illustrates an embodiment of the current disclosure when a first network device 101 has an enclave 104 comprising a group of twinned network functions 607, 608, 609, together as a part of a service 605. The twinned network functions correspond to a group of hosted network functions 617, 618, 619, the hosted network functions being together as a service 615, the service corresponding to service 605 which all reside in a fourth network device 103. The figure also includes a second network device 102 that comprises at least the functionality of a network manager. Lines with arrows and numbers indicate information flows from one module to another.

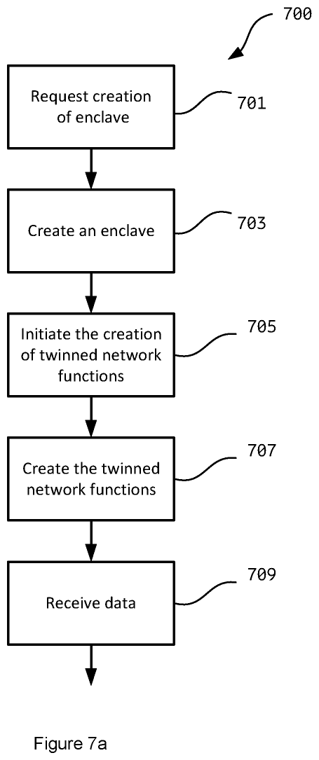

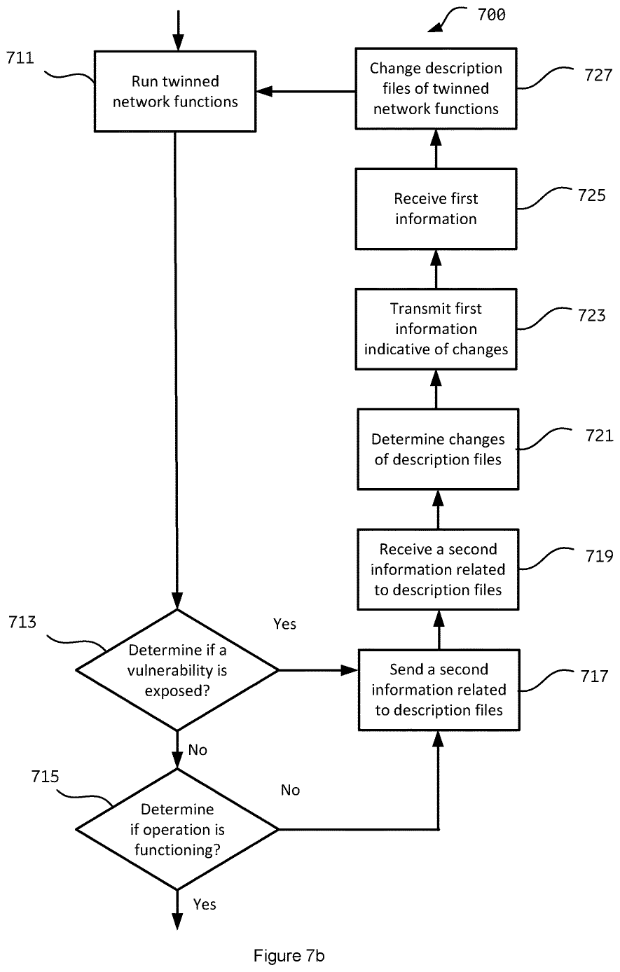

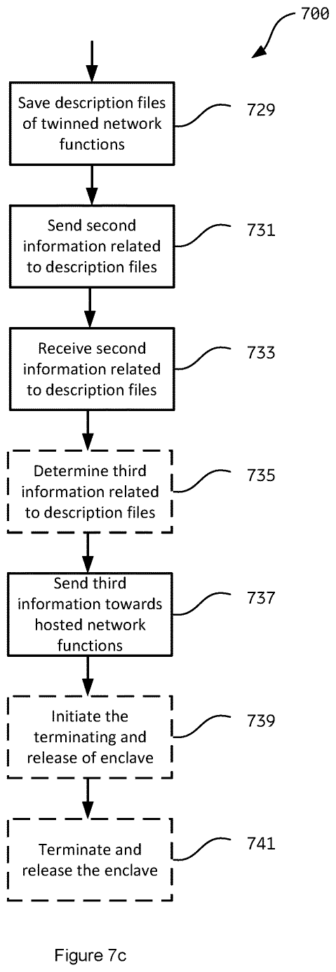

FIG. 7 schematically illustrates the method 700 of the same embodiment of Figure XYZ, where the enclave comprises a group of twinned network function together as a part of a service.

In a first step 701 indicated by the data flow labeled number one, the second network device requests the first network device to allocate computer resources to the creation of an enclave. In a second step 703, the first network device creates the enclave, the enclave capable of receiving input data associated with the computer network and transmitting data to the second network device. The enclave is located in a protected storage medium and run-on processing circuitry separate from other hosted network functions that may be running on the first network device or the computer network. Once allocated, the second network device, in a third step 705 and indicated by data flow 2, initiates the creation of a group of twinned network function within the enclave by instructing the first network device to copy and initialize a group of twinned network functions based on a group of the hosted network functions together part of a service. In the current embodiment, the hosted network functions are hosted by a fourth network device separate from the first network device hosting the enclave. Then in a fourth step 707, the first network function then creates the group of twinned network functions and service based on the group of hosted network functions and service in the computer network.

In the group of functions embodiment, the description files comprise both a descriptor file for the group of hosted network functions but also description files and image files for each hosted network function. Examples of this include services comprising multiple network functions and infrastructure as a service implementation comprising multiple services. This would be the case for a core network in a 3GPP complaint communications network.

The group of hosted network function are running as a service in multiple Docker containers implemented using Docker Compose or Kubernetes with the example descriptor file from the description files:

```
services:
  service_1:
    image: NF_1 image
    image: NF2_ image
    networks:
      nw1
      nw2
    ports:
      22:22
    deploy:
      mode: replicated
      replicas: 3
```

In a fifth step 709 indicated by data flows 3 and 4, the first network device replicates the input information being used by the group of hosted network functions, which in the embodiment is a result of the second network device indicating to the fourth network device and the fourth network device copying the input information, indicated by data flow 4a, being used by the group of hosted network functions. The input information, indicated as data flow 4b, is received by the first network device and brought into the enclave, towards the group of twinned network functions. The input information, if manipulated, should be still useable or compatible by one, a sub-group, or the entire group of hosted network functions.

In a sixth step 711, the first network function uses the input information to run the group of twinned network functions. In the current embodiment, the first network function does this by having the enclave take in the replicated input data flow, labeled as 4b, and the twinned network function begin to process it according to the description file or files. The group of twinned network functions may also take in the outputted information from itself as an input information such as indicated by data flow 4c.

The first network device, in a seventh step 713, will then determine, using the enclave, from an output of the twinned network function, if the output exposes a vulnerability. This may be done with the analysis of the output information from the group of twinned network functions and thereby determining whether there are any exposed vulnerabilities. The first network device will also, in an eighth step 715, determine if the output indicates that the group of twinned network functions have ceased to operate according to operation criteria set for the group of hosted network functions. In certain embodiments, this may be done by analyzing not only the output data from the group of twinned network devices, or in other words, the service but also by analyzing each individual output from each twinned network function in the group and the combined output of subsets of the group of twinned network functions. In certain embodiments, this analysis may be augmented by also taking the data flow 5a which is a copy of the output of the group of the hosted network functions, shown as data flow 5 and comparing the data flow against the output data from the group of twinned network functions. This comparing step may also occur with individual outputs from the twinned network functions or the combined outputs of subsets of the group of twinned network functions.

In the current embodiment, the results of the analysis will determine that the group of twinned network functions in the form of service 605 performs according to the quality-of-service requirements associated to the group of hosted network functions in the form of 615. However, the results of the analysis, in the form of the vulnerability scan, will determine that the group of twinned network functions have exposed vulnerabilities in the form of the risk that with port 22 exposed, trying to use SSH with default account names and passwords constitutes a catastrophic vulnerability.

In a ninth step 717 indicated by data flow number 6, the first network device will send a second information to the second network device, the second information related to the description files of the group of twinned network functions. The second information may comprise the description files of the group of twinned network functions, information related to exposed vulnerabilities, information related to the operation of the group of twinned network functions, the operational criterion, information related to the group of twinned network functions ceasing to operate according to the operational criterion. In a tenth step 719, the second network device will receive the second information related to the description files of the group of twinned network functions.

In an eleventh step 721, the second network device will determine changes to be made to the description files. These changes may be determined by the network device, a different network device or a person. The changes may be made to rectify an exposed vulnerability or change the operation of the group of twinned network functions to operate closer to the operational criteria set for the hosted network function. In the current embodiment, these changes are at least having the service either closing port 22 and/or to update any account names and passwords and may likely involve a deeper change in either the descriptor files of one of the twinned network functions or the image file of the service that prevents the service from opening port 22 in the first place.

In a twelfth step 723 the second network device sends, as indicated by data flow number 7, a first information indicative of changes to the description files associated with the group of twinned network functions. In a thirteenth step 725, the first network device receives the first information from the second network device.

In a fourteenth step 727, the first network device will use the first information sent from the second network device associated with changes to the description files to then update the description files of the group of twinned network functions.

After the change is made to the description file or files, the network device will return to the sixth step and proceed through to step eight. No further vulnerabilities will have been detected and now all quality-of-service requirements associated with the group of hosted network functions will have been met and thereby the operational criteria of the group of hosted network functions. No further changes are necessary, and the method will proceed to step fifteen.

In other embodiments, the change made to the description file or files will lead to further vulnerabilities being detected and/or the quality-of-service requirements or similar performance characteristics not being met despite multiple iterations of steps six through fourteen. The first network device or second network device may after a certain number of iterations, may decide to halt method 700 and alert a user or other network function of the failure of method 700. The network devices may also cause method 700 to proceed to step fifteen while certain exposed vulnerabilities are still detected, or the operational criteria of the hosted network functions are still unmet. The user or other network function will be sent the description files along with the vulnerabilities found and performance characteristics that did not meet requirements. In first network device or second network device may also wait to halt method 700 for a certain predetermined length of time, an input from a user or an input from a different network function.

After the change is made to the description files, the first network device returns to steps six and proceed through to step eight. If the analysis from the repeated steps seven and eight determines that there are no exposed vulnerabilities and that the group of twinned network functions operate according to operational criteria set for the group of hosted network functions, the first network device may, in a fifteenth step 729, save the description files of the group of twinned network functions. These description files may be considered to the be ‘golden configuration’ of the twinned network function. The first network device will, in a sixteenth step 731, send, as indicated by data flow 8, the second information to the second network function, the second information related to the description files of the group of twinned network functions. In a seventeenth step 733, the second network function will receive the second information from the first network device. The second information may be, the new description files saved by the first network device, as the description files related to the latest version of the twinned network function. The second information may be an affirmation that the original descriptor files copied from the group of the hosted network functions have no determined exposed vulnerabilities and operate according to the operational criteria and that no changes are necessary. The second information may be the information associated with the changes made to the description files in one or more iterations of steps 711 through 727. In an optional eighteenth step 735, the second network device, will determine a third information, the third information indicative of the description files of the group of twinned network functions. The third information is based on the second information and may be new description files based on the second information, an affirmation that the original descriptor files copied from the group of hosted network functions have no determined exposed vulnerabilities and operate according to the operational criteria and that no changes are necessary or may be information associated with changes made to the description files.

In a nineteenth step 737 indicated by data flow number 9, the second network device will send a third information towards the group of hosted network functions associated with the group of twinned network functions, the third information being indicative of the updated description files. The second network device will then initiate in the fourth network device the reinitialization of the group of hosted network functions and associated service with the updated description files.

In an optional twentieth step 739, the second network device then initiates the termination of the enclave and/or release of the computational resources associated with the enclave. This can be done to possibly save the network device computational resources for use by other network functions such as the group of hosted network functions in the network device. In an optional twenty-first step 741, the first network device then terminates the enclave and/or releases the computational resources associated with the enclave.

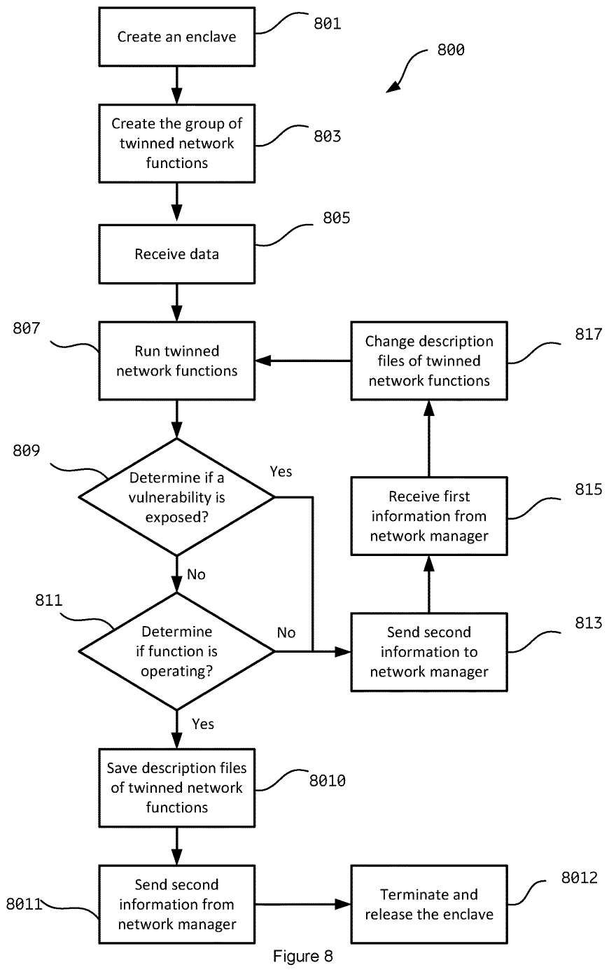

FIG. 8 schematically illustrates the method 800 of the same embodiment as in FIG. 6 and FIG. 7, the method 800 performed by the first network device. The steps of method 800 share common steps as those performed by the first network function in method 700.

In a first step 801, the first network device creates the enclave, the enclave capable of receiving input data associated with the computer network and transmitting data to the second network device. In a second step 803, the first network device creates and initializes the group of twinned network functions based on a group of the hosted network functions in the computer network. The twinned network function will run in multiple docker containers using Docker Compose or Kubernetes with description files from the group of hosted network functions. In a third step 805, the first network device replicates the input information being used by the group of hosted network functions. The input information may be replicated input information that was or is sent to the group of hosted network functions, wherein the input information has been manipulated to add, subtract, or change information in the replicated input information used by the group of hosted network functions. The input information should be still useable by or compatible with the group of hosted network functions.

In a fourth step 807, the first network device uses the input information to run the group of twinned network functions, the group of twinned network functions residing inside the enclave. In some embodiments, the group of twinned network functions may also take in the outputted information from itself as an input information. In a fifth step 809, the first network function will then determine, using the enclave, from an output of the group of twinned network functions if the output exposes a vulnerability. This may be done with the analysis of the output information from the group of twinned network functions and thereby determining whether there are any exposed vulnerabilities. The first network device will also, in a sixth step 811, determine if the output indicates that the group of twinned network functions have ceased to operate according to operation criteria set for the group of hosted network functions.

In an embodiment, if the results of the analysis have determined there are no exposed vulnerabilities and if the group of twinned network functions operate according to the operation criteria set for the group of hosted network devices, the first network device proceeds to step ten. In the current embodiment, the analysis of the output data and the description files reveal an exposed vulnerability. Due to the exposed vulnerability, the first network device will proceed to step seven.

In a seventh step 813, the first network device will send a second information to the network manager, the second information related to the description files of the twinned network files. In an eighth step 815, the first network device will receive a first information from the network manager, the first information indicative of changes to the description files associated with the group of twinned network functions. Using the first information from the network manager, the first network device will use the first information associated with changes to the description files to then update the description files of the group of twinned network functions. In a ninth step 817, the first network device will use the first information sent from the second network device associated with changes to the description files to then update the description files of the group of twinned network functions.

After the change is made to the description files, the first network device returns to step four and proceeds through to step six. If the analysis from the repeated steps four through six determines that there are no exposed vulnerabilities and that the group of twinned network functions operate according to operational criteria set for the group of hosted network functions, the first network device may, in a tenth step 819 save the description files of the group of twinned network functions. The first network device will, in an eleventh step 821, send the second information to the network manager, the second information related to the description files of the twinned network function. Finally in an optional twelfth step (823), the first network function terminates the enclave and/or release the computational resources associated with the enclave.

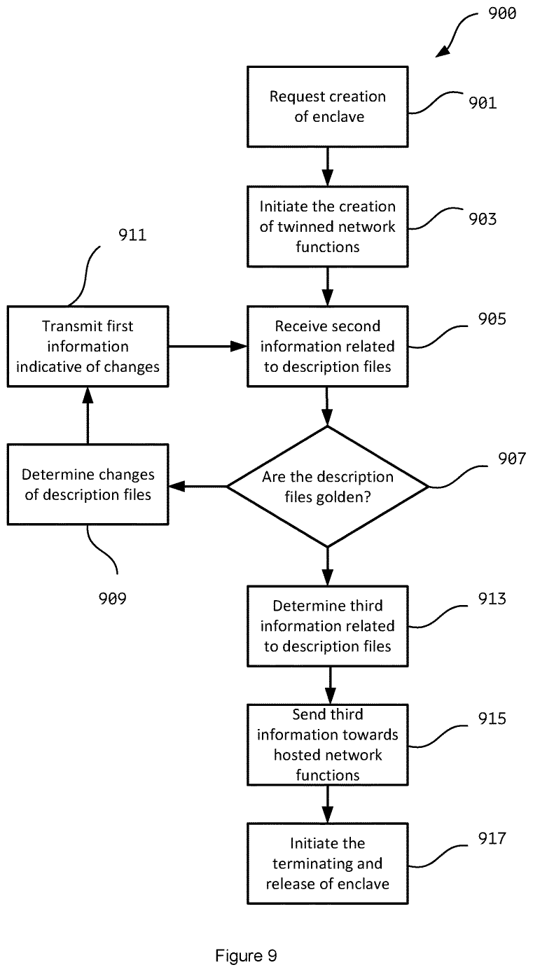

FIG. 9 schematically illustrates the method 900 of the same embodiment as in FIG. 6 and FIG. 7, the methods performed by the second network device. The steps of method 900 share common steps as those performed by the second network function in method 600 apart from step 907 which is implicit in method 700.

In a first step 901, the second network device requests the first network device to allocate computer resources to the creation of an enclave. In a second step 903, the second network device initiates the creation of a group of twinned network functions within the enclave of the first network device, by, in an embodiment, instructing the first network device to copy and initialize the group of twinned network functions, the group of twinned network functions based on one group of the hosted network functions in the computer network. As a part of this initialization, the second network device may also indicate to the first network device to replicate the input information. The second network device may also indicate to a fourth network device hosting the hosted network device to send the input information to the first network device.

In a third step 905, the second network device receives, from the first network device, the second information related to description files of the group of twinned network functions. The second information also contains an indication if the group of twinned network functions are satisfactory, which in the current embodiment, means that the group of twinned network functions did not have an exposed vulnerability and was operating according to operation criteria set for the group of hosted network functions.

In a fourth step 907, the second network devices determines if the group of twinned network functions and/or the description files are satisfactory based on the indication provided from the second information.

If not satisfactory, the second network device proceeds with a fifth step 909, where the second network device will determine changes to be made to the description files. In a sixth step 911, the second network device will then transmit a first information to the first network device, the first information indicative of changes to the description files associated with the group of twinned network functions. The method 900 will then return to the third step with a new second information and proceed to the fourth step.

If in the fourth step, the indication was satisfactory, the second network device, in a seventh step 913, will determine a third information, the third information indicative of the description files of the group of twinned network functions. Then in an eighth step 915, the second network device will send a third information towards the group of hosted network functions associated with the group of twinned network functions. The third information or the second network device may then initiate, in the third network device, the reinitialization of the group of hosted network functions with the updated description files.

In an optional ninth step 917, the second network device, then initiates the termination of the enclave in the first network device and/or release of the computational resources associated with the enclave in the first network device.

FIG. 10 schematically illustrates an embodiment of the invention where the network contains a third network function 1001 which comprises an enclave 104, a hosted network function 106, two twinned network functions 105a, 106b, and a manager network function 1002 comprising the functionality of a second network device which possess the functionality of a network manager. Lines with arrows and numbers indicate information flows from one module to another. The previous two embodiments are similar to the current embodiment and share the same core inventive concepts with the main difference being the placement and number of certain nodes particularly regarding the concept that the third network device comprises a network manager function instead of the embodiment comprising a second network device comprising a network manager function. In some embodiments, the third network device is also capable of performing according to the first network device, the second network device, and the combination of the two devices as presented in previous embodiments. Method 1100 will hereby be described as to how it applies to the embodiment presented in FIG. 10.

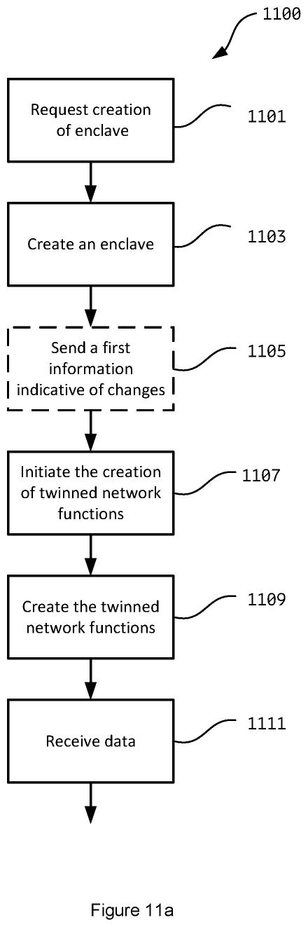

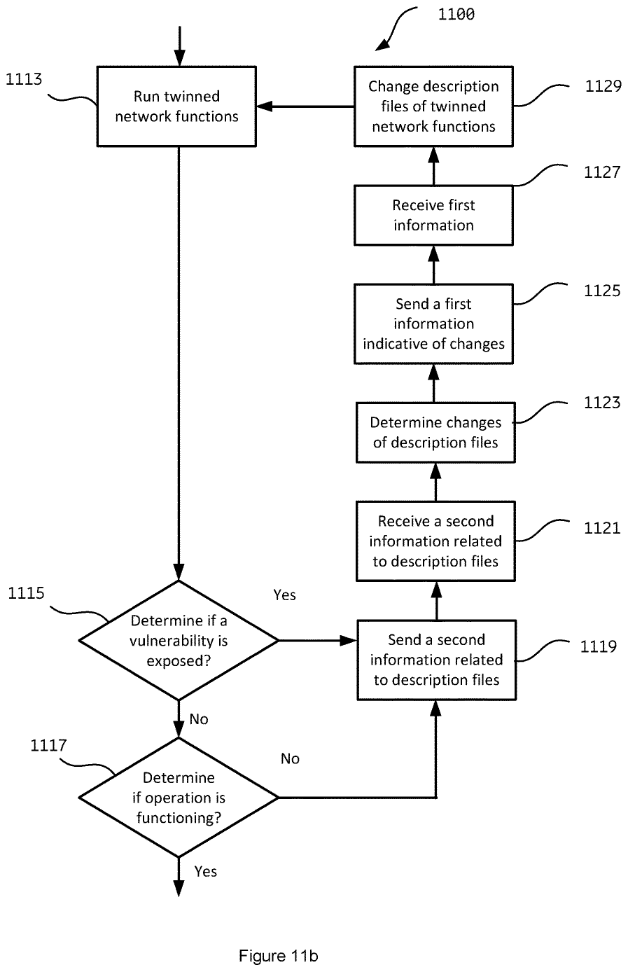

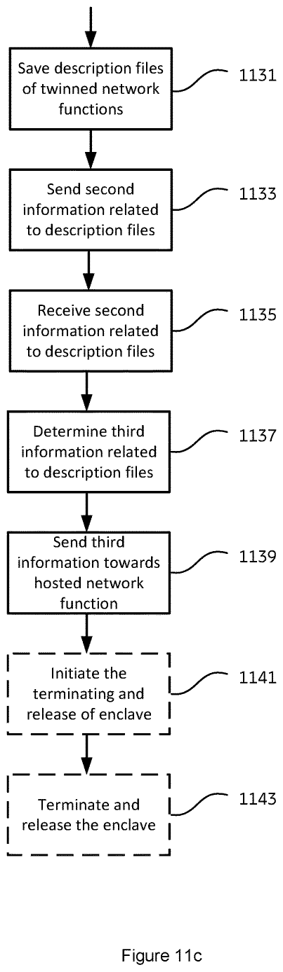

FIG. 11 schematically illustrates the method 1100 of the same embodiment of FIG. 10, where the enclave comprises multiple copies of a twinned network function. In a first step 1101 indicated by the data flow numbered one, the network manager of the third network device requests the third network device to allocate computer resources to the creation of an enclave. In a second step 1103, the third network device creates the enclave, the enclave capable of receiving input data associated with the computer network and transmitting data to the second network device. The enclave is located in the third network device and uses the third network devices processing circuitry and storage mediums as other network functions running on the third network device. The enclave and the other network functions are however separated through software such as through the use of a container or virtual machine. Once allocated, the network manager function in an optional third step 1105 indicated by data flow two, sends a first information indicative of changes to description files of hosted network function, that will be the basis of the twinned network functions whose creation is initiated in a fourth step 1107. This may be done by the network manager function instructing the fourth network device to copy and multiple instances of description files of the twinned network functions, each twinned network function based on a single hosted network function. The first information may comprise individual changes to the description files, new description files comprising the changes, or some other indication of changes to the description files. These changes may originate from the third network device or an external device, person, or network. Instances in which this is advantageous may be in the testing of multiple different revisions to the hosted network function that a developer may have created. This optional step may also apply to other embodiments such as those presented in FIGS. 1 and 6.

In the fourth step 1107, the network manager function initiates the creation of multiple instances of a twinned network function within the enclave of the third network device, the multiple instances of the twinned network function based on the first information associated with the hosted network function within the computer network. In other embodiments, there may be more than two twinned network functions in the enclave or two or more enclaves each with one or more twinned network functions inside each enclave. Similarly, there may be multiple services in an enclave or multiple infrastructures as code inside an enclave.

The in a fifth step 1109, the third network device then creates the multiple twinned network functions based on one of the hosted network functions in the computer network.

In the current embodiment, the hosted network function is running in a docker container with the descriptor file from the description files, the descriptor file shown below:
FROM python: 2.6-slim
WORKDIR/usr/src/app
RUN pip install pandas
RUN apt-get update && apt-get install-y nano
CMD [“python”, “./app.py”]

Upon receiving the instructions from the network manager function, the third network device initializes the network function according to the descriptor file in the enclave. This forms the twinned network function. In a sixth step 1109 indicated by data flow 3 and 4, the third network device replicates the input information being used by the hosted network function, which in the current embodiment is a result of the second network device indicating to the third network device to replicate input information. The third network device receives the input information into the enclave, toward the twinned network functions. In some embodiments, the input information may be replicated input information that was or is sent to the hosted network function, wherein the input information has been manipulated to add, subtract, or change information in the replicated input information used by the hosted network function. The input information should be still useable or compatible by the hosted network function. An example of this may be that input information is filtered to remove data extraneous or irrelevant to the purpose of the hosted network function and therefore the twinned network function so that the input information is smaller in size.

In steps 1113 through 1129, each twinned network function in the first network device is independent of the other twinned network functions. In other words, the first twinned network functions may proceed through steps 1113 to 1127 and eventually to 1131, 1133, and 1135 independently of the other twinned network functions, depending on the same or different changes made to the description files of the twinned network functions. For example, the change made to the descriptor file of the first twinned network function may cause method 1100 to proceed from 1113 through both 1115 and 1117, straight to 1131 while the second network function may pass from 1113 through to 1129 multiple times before moving to 1129.

In a seventh step 1113, the third network function uses the input information to run the twinned network functions. In the current embodiment, the third network function does this by having the enclave take in the replicated input data flow, labeled as 4b, and the twinned network functions begin to process it according to their description files. The twinned network functions may also take in the outputted information from themselves or other replicated twinned network functions as an input information.

The third network device, in an eighth step 1115, will then determine, using the enclave, from an output of one or more of the twinned network functions, if one or more of the outputs exposes a vulnerability. This may be done with the analysis of the output data from each of the twinned network functions and determine whether or not there are any exposed vulnerabilities. The third network device will also, in a ninth step 1117, determine if the output indicates that the group of twinned network functions have ceased to operate according to operation criteria set for the group of hosted network functions. In certain embodiments, this may be done by analyzing the output data from each of the twinned network functions and possibly comparing them against the outputs of the other twinned network functions. In certain embodiments, this analysis may be augmented by also taking the data flow 5a which is a copy of the output of the hosted network function, shown as data flow 5 and comparing the data flow against the output data from the twinned network functions.

In the current embodiment, the analysis of the output data and the descriptor file will reveal an old release of a non-compatible version of the python codebase, python version 2.6, that the twinned network devices are running. In a tenth step 1119 indicated by data flow number 6, the third network device will send a second information to the network manager function, the second information related to the description files of the one or more twinned network files. The second information may comprise the description files of the one or more twinned network functions, information related to exposed vulnerabilities, information related to the operation of the one or more twinned network functions, the operational criterion, information related to the one or more twinned network functions ceasing to operate according to the operational criterion. In an eleventh step 1121, the third network device will receive, at the network manager function, the second information related to the description files of the one or more twinned network functions.

In a twelfth step 1123 the network manager of the third network device will determine changes to be made to the description files. These changes may be determined by the network device, a different network device or a person. The changes may be the same or different for each twinned network device. In the current embodiment, the changes are different. In the current embodiment these changes are to update from python 2.6 to python 3.8 for the first twinned network function 105a and from python 2.6 to python 2.7 for the second twinned network function 105b. In a thirteenth step 1125, the third network device sends, from the network manager function, a first information indicative of changes, the changes determined in step 1123, to the description files associated with one or more of the twinned network functions.

In a fourteenth step 1127, the third network device will receive a first information, possibly different in content but the same in structure and purpose as the first information from optional step 1105, from the network manager, the first information indicative of changes to the description files associated with the twinned network function.

In a fifteenth step 1129, the third network device will use the first information sent from the second network device associated with changes to the description files to then change the description files of the one or more twinned network functions.

After the change is made to the descriptor files of the one or more twinned network functions, the network device returns to step 1113 and proceeds through to step 1117 for each of the two twinned network functions. If the analysis from the repeated steps 1115 and 1117 determines that there are no exposed vulnerabilities and that both the twinned network functions perform in the same way as the hosted network function, the new descriptor files, in a sixteenth step 1131, will be saved by the third network device as the description files related to the latest version of the twinned network functions.

In this embodiment however, first twinned network function has the same dependency problem as described in the first embodiment. The second twinned network function however does not have the same dependency problem but instead contains the vulnerability that python 2.7 is no longer a supported version of the python codebase and is therefore vulnerable to several exploits with no recourse.

The first twinned network function 105a will repeat steps 1119 through 1129 where a change is made in the descriptor files where the newest version of the NumPy library is installed and steps 1113 through 1117 being conducted again. Ideally, from there the third network device proceeds with steps 1113 through 1115 where the step determines that exposed vulnerabilities have been found and the network function performs in the same way as the hosted network function and therefore move to step nine. However, given the significant change in the python codebase from 2.6 to 3.8, it is highly likely that several more dependencies have also broken, and new vulnerabilities have been created. This will necessitate the iteration of steps 1113 through 1129 several times before all issues have been addressed and no exploitable vulnerabilities are detected. This showcases the significant benefit of the invention whereby the invention enables such iterative improvement of the security and performance of the network functions through the twinned network function. This is simply not possible to accomplish using the hosted network function.

The second network function 105b will also repeat steps eight where a change is made in the descriptor files where the python codebase is updated to python 3.8. From here the second twinned network function will proceed in functionally the same way as the first twinned function by iterating through steps 1113 to 1129 until no exposed vulnerabilities are detected and all operation criteria are met. In other embodiments, the change made to the descriptor files may be intentionally different from the change made to the first twinned network functions. Such changes, and the subsequent iterative process thereby enabled, may allow for multiple different solutions to an underperforming or nonfunctional twinned network function or an exposed and exploitable vulnerability to be tested, improved, and validated on equivalent real time data flows without the need for lengthy downtime or unnecessary risk to operating and exposed network resources.

Once either the first or second twinned network functions result in description files that function as the hosted network function, satisfy performance metrics, and have no exposed and exploitable vulnerabilities, the description files related to the latest version of the twinned network function are saved in the sixteenth step 1131 by the third network device.

The third network device will, in a seventeenth step 1133, send, as indicated by data flow 8, the second information to the network manager function, the second information related to the description files of one or more of the twinned network functions. In an eighteenth step 1135, the network manager function will receive the second information from the third network device.

In the current embodiment, the network manager function will then wait to perform the nineteenth step 1137 until steps 1131, 1133, and 1135 have been also performed in relation to other twinned network functions that have yet to finish performing steps 1113 through 1129. In other embodiments, the network manager function will proceed directly to step 1137 after the steps 1131, 1133, and have been performed in relation to at least one of the twinned network functions. In other embodiments, the network manager function may wait for a certain length of time, a certain number of iterations of steps 1113 through 1129, or an input from a user or another network function.

In the nineteenth step 1137, the network manager function will then determine a third information indicative of description files. The network manager determines the third information associated with one of a set of twinned network functions from the different sets of second information associated with the different twinned network functions in the set of twinned network functions. This determining may be based on: the description files with the fewest changes compared to the description files associated with the hosted network function; the description files that result in the best performance of the twinned network function or the best performance of the network device or the best performance of the communications network; the description files that cause the twinned network function to operate according to or exceeding the operational criteria of the hosted network function or external network functions; the description files that contain the fewest number of detected vulnerabilities; and/or the description files received by the network manager function. This decision may also be made through the input of a user. Best performance may be defined as the highest or lowest value of a performance metric, the closest or farthest exceeding value for a quantitative or qualitative requirement, or other most optimal value for a given criteria related to network operation.

Once the network manager function has determined a third information, the network manager function, in a twentieth step 1139 indicated by data flow 9, will send a third information towards the hosted network function associated with the group of twinned network functions, the third information being indicative of description files which in the present embodiment are the updated descriptor file to third network device. The network manager function then initiates in the network device the reinitialization of the hosted network function with the updated descriptor files.

In an optional twenty-first step 1141, the third network device, via the network manager function, then initiates the termination of the enclave and/or release of the computational resources associated with the enclave. This can be done to possibly save the network device computational resources for use by other network functions such as the group of hosted network functions in the network device. In an optional twenty-second step 1143, the third network device then terminates the enclave and/or releases the computational resources associated with the enclave.

In embodiments of the invention, the description files comprise at least descriptor files or image files or files performing similar functions. The description files may also contain both descriptor files and image files or other files that are essential to the operation of virtual network functions. Description files may also comprise a single file or other single unit of information essential to the operation of virtual network functions. Examples of such description files include but are not limited to docker and machine images, docker and yaml compose files, helm files, day-x-scripts, infrastructure as Code files such as terraform. It is well documented in the state of the art how to implement vulnerability scanning of description files. In embodiments of the invention, the enclave includes but are not limited to containers used by computer programs such as docker, virtual machines running on computer hardware, and secured enclaves running on physically separated processor circuitry and unconnected to processor circuitry running hosted network functions.

In embodiments of the invention, a network function is a functional block within a network infrastructure that has well-defined external interfaces and well-defined functional behavior. Virtual network functions are implementations of network functions that can be deployed on a Network Function Virtualization Infrastructure which is the totality of all hardware and software components that build up the environment in which virtual network functions are deployed. Such infrastructure can span across several locations e.g. places where data centers are operated. The network providing connectivity between these locations is also regarded to be part of the infrastructure.

In embodiments of the invention, replicated data streams is data that, in normal operation of the hosted network function, would be used as an input to the hosted network function. The replicated data streams are used as an input to the one or more twinned network functions. The replicated data streams are either an exact duplicate of the data inputted to the hosted network function or substantially the same as the data inputted to the hosted network function. Substantially the same may also mean that the data is of the same content and/or purpose but may be formatted differently.

In embodiments of the invention, the method XX0 may not have the strict requirement of no exposed and exploitable vulnerabilities. Instead the method XX0, in steps XX5 and XX6 may use a risk metric to determine if the exposed and/or exploitable vulnerabilities are either sufficiently difficult to exploit; statistically unlikely to be exploited based on previously gathered data of attacks; or where the mitigation impacts performance in such a way as to either not satisfy the KPIs of a service level agreement, the requirements of quality of service, or to match the performance of the hosted network function.

A network device is an electronic device that, when activated, communicatively interconnects other electronic devices on the network (e.g. other network devices, end-user devices, etc.). A network device may host, in whole or partially, network functions, containers, or virtual machines. Network functions are software operating as, but are not limited to, microservices and/or functions in a network such as firewall, packet inspection, packet filtering, and more.

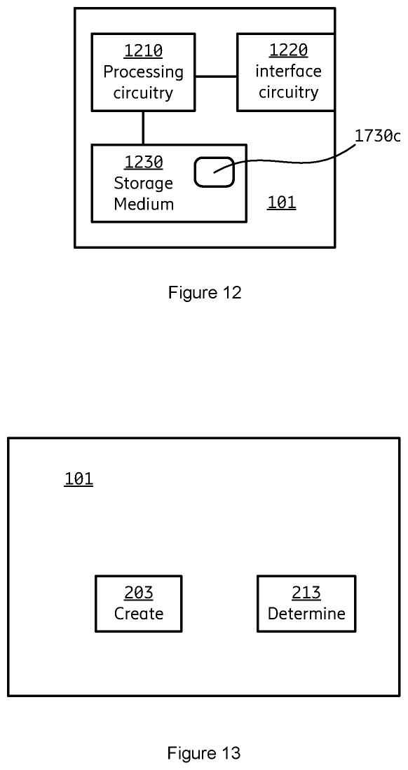

FIG. 12 is a block diagram of the first network device 101 according to some embodiments. As shown in FIG. 12, the first network device 101 may comprise: processing circuitry 1210 which may include one or more processors (e.g., a general purpose microprocessor and/or one or more processors, such as an application specific integrated circuit (ASIC), field-programmable gate arrays (FPGAs) and the like); interface circuitry 1220 for communicating with other nodes connected to a computer network 100; and a storage medium 1230 which may include one or more non-volatile storage devices and/or one or more volatile storage devices (e.g., random access memory (RAM)). In embodiments where the smart proxy includes a programmable processor 1210, a computer program product may be provided. A computer program product includes a computer readable medium 1220 such as, but not limited to, the storage medium 1230, magnetic media (e.g., a hard disk), optical media, memory devices, and the like. The storage medium may contain a computer program 1730a containing computer readable instructions 1740a that when executed by the processor circuit 1210 causes the processor circuit to perform operations according to embodiments disclosed herein. According to other embodiments, processor circuitry 1210 may be defined to include a storage medium so a separate storage medium is not required.

FIG. 13 is a diagram showing functional units of a first network device 101 according to some embodiments. As shown in FIG. 13, the first network device 101 comprises a number of functional modules; a create module configured to perform step 203/step 703 and a determine module configured to perform step 213/step 215/step 713/step 715. In general terms, each functional module may be implemented in hardware or in software. Preferably, one or more or all functional modules may be implemented by the processing circuitry, possibly in cooperation with the interface circuitry and/or the storage medium. The processing circuitry may thus be arranged to, from the storage medium, fetch instructions, thereby performing any steps of the first network device 101 as disclosed herein.

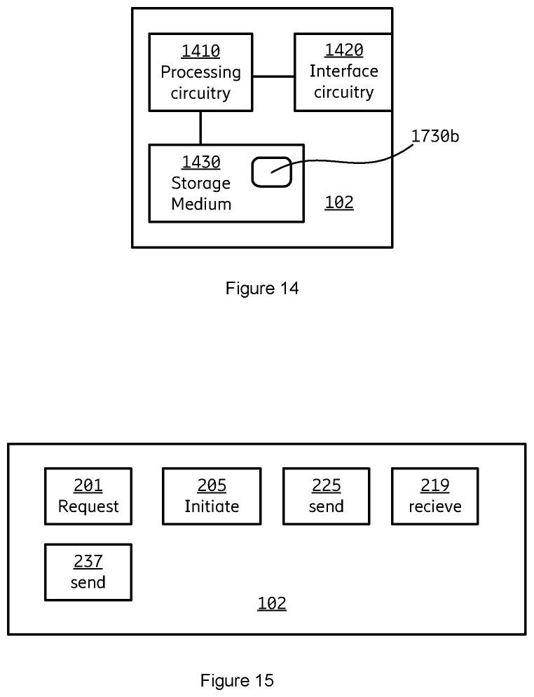

FIG. 14 is a block diagram of the second network device 102 according to some embodiments. As shown in FIG. 14, the second network device 102 may comprise: processing circuitry 1410 which may include one or more processors (e.g., a general purpose microprocessor and/or one or more processors, such as an application specific integrated circuit (ASIC), field-programmable gate arrays (FPGAs) and the like); interface circuitry 1420 for communicating with other nodes connected to a computer network 100; and a storage medium 1430 which may include one or more non-volatile storage devices and/or one or more volatile storage devices (e.g., random access memory (RAM)). In embodiments where the smart proxy includes a programmable processor 1410, a computer program product may be provided. A computer program product includes a computer readable medium 1420 such as, but not limited to, the storage medium 1430, magnetic media (e.g., a hard disk), optical media, memory devices, and the like. The storage medium may contain a computer program 1730b containing computer readable instructions 1740b that when executed by the processor circuit 1410 causes the processor circuit to perform operations according to embodiments disclosed herein. According to other embodiments, processor circuitry 1410 may be defined to include a storage medium so a separate storage medium is not required.

FIG. 15 is a diagram showing functional units of a second network device 102 according to some embodiments. As shown in FIG. 15, the second network device 102 comprises a number of functional modules; a request module configured to perform step 201/step 701; an initiate module configured to perform step 205/step 207; a send module configured to perform step 225/step 725; a receive module configured to perform step 219/step 719; and a send module configured to perform step 237/step 737. In general terms, each functional module may be implemented in hardware or in software. Preferably, one or more or all functional modules may be implemented by the processing circuitry, possibly in cooperation with the interface circuitry and/or the storage medium. The processing circuitry may thus be arranged to, from the storage medium, fetch instructions, thereby performing any steps of the first network device 101 as disclosed herein.

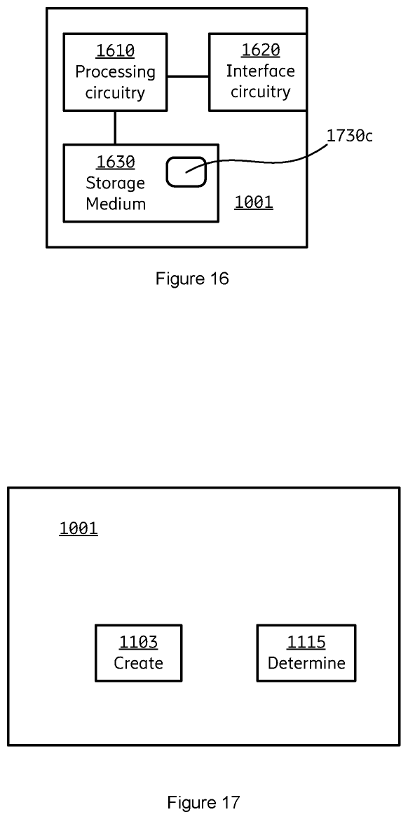

FIG. 16 is a block diagram of the third network device 1001 according to some embodiments. As shown in FIG. 16, the third network device 1001 may comprise: processing circuitry 1610 which may include one or more processors (e.g., a general purpose microprocessor and/or one or more processors, such as an application specific integrated circuit (ASIC), field-programmable gate arrays (FPGAs) and the like); interface circuitry 1620 for communicating with other nodes connected to a network; and a storage medium 1630 which may include one or more non-volatile storage devices and/or one or more volatile storage devices (e.g., random access memory (RAM)). In embodiments where the smart proxy includes a programmable processor 1610, a computer program product may be provided. A computer program product includes a computer readable medium 1620 such as, but not limited to, the storage medium 1630, magnetic media (e.g., a hard disk), optical media, memory devices, and the like. The storage medium may contain a computer program 1730c containing computer readable instructions 1740c that when executed by the processor circuit 1610 causes the processor circuit to perform operations according to embodiments disclosed herein. According to other embodiments, processor circuitry 1610 may be defined to include a storage medium so a separate storage medium is not required.

FIG. 17 is a diagram showing functional units of a third network device 1001 according to some embodiments. As shown in FIG. 13, the first network device 1001 comprises a number of functional modules; a create module configured to perform step 1103 and a determine module configured to perform step 1115/step 1117. In general terms, each functional module may be implemented in hardware or in software. Preferably, one or more or all functional modules may be implemented by the processing circuitry, possibly in cooperation with the interface circuitry and/or the storage medium. The processing circuitry may thus be arranged to, from the storage medium, fetch instructions, thereby performing any steps of the first network device 1001 as disclosed herein.

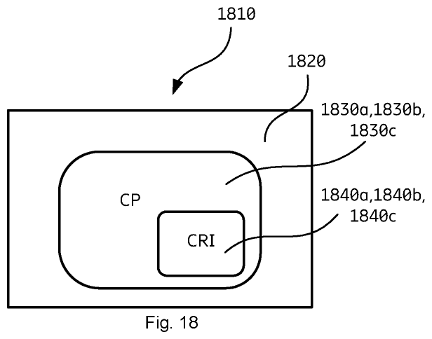

FIG. 18 is a diagram showing an embodiment of the invention. As shown in FIG. 18, the computer program product 1810 comprises a computer readable medium 1820 storing a computer program 1830a, 1830b, 1830c, comprising computer readable instructions 1840a, 1840b, 1840c. The computer readable medium may be but is not limited to, a storage medium 1230, 1430, 1630, magnetic media (e.g., a hard disk), optical media, memory devices (e.g., random access memory, flash memory) and the like.

Also, while various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel. Particularly, steps 213 and 215 as well as 713 and 715 maybe switched out for each other or either one may be skipped dependent on the specific purpose of the embodiment of the invention.

1.-43. (canceled)

44. A first network device configured for use in a computer network, the first network device configured to host a network function and to connect to a second network device that possesses capabilities of a network manager function, wherein the first network device comprises:
processor circuitry and a storage unit storing instructions which when executed by the processor circuitry causes the first network device to become operative to:
create an enclave, the enclave capable of receiving input information associated with the computer network and transmitting information to the second network device; and
determine, using the enclave, from an output of a twinned network function based on a hosted network function, after using the input information to run the twinned network function, if the output exposes a vulnerability or if the output indicates that the twinned network function has ceased to operate according to operational criteria set for the hosted network function, whereby either:
a change is made to description files associated with the twinned network function if the output exposes a vulnerability or if the twinned network function has ceased to operate according to the operational criteria set for the hosted network function; or
information related to the description files is sent to the second network device to update the hosted network function.

45. The first network device of claim 44, wherein the enclave causes the first network device to become operative to determine, from an output of a group of twinned network functions cloned from a group of hosted network functions after using the input information sent to the group of hosted network functions to run the group of twinned network functions, if the output exposes a vulnerability or the output indicates that the group of twinned network functions have ceased to operate in substantially the same way as the group of hosted network functions whereby a group of network functions comprises a shared description file associated with the group and each network function in the group comprises a description file associated with the network function.

46. The first network device of claim 44, wherein the enclave is only capable of receiving information from:
hosted network functions;
groups of hosted network functions;
external computer networks; and/or
the second network device.

47. The first network device of claim 44, wherein the processor circuitry causing the first network device to be operative to create the enclave is separated from other processor circuitry of the first network device.

48. The first network device of claim 44, wherein the storage unit is encrypted and separate from other storage of the first network device, the storage unit storing instructions which when executed by the processor circuitry causes the first network device to become operative to create and/or run the enclave.

49. The first network device of claim 44, wherein the enclave causes the network device to become operative to determine if the changed description files create an exposed vulnerability in the first network device, the determining done by conducting a vulnerability scan of one of:
the description files;
the twinned network function; or
the output of the twinned network function.

50. The first network device of claim 44, wherein the enclave causes the first network device to become operative to determine if the changed description files cause a twinned network function to cease operating according to operational criteria.

51. The first network device of claim 44, wherein the instructions, when executed by the processor circuitry, further cause the first network device to become operative to:
terminate the enclave; and/or
release computational resources associated with the enclave.

52. A second network device configured for use in a computer network, the second network device configured to connect to a first network device adapted to host a network function, wherein the second network device comprises:
processor circuitry and a storage unit storing instructions which when executed by the processor circuitry causes the second network device to become operative to:
request, of the first network device, the creation of an enclave in the first network device;
initiate the creation of a twinned network function within the enclave of the first network device, the twinned network function based on a hosted network function in the computer network;
send first information indicative of a change to description files associated with the twinned network function;
receive, from the first network device, second information related to the description files of the twinned network function; and
send, towards the hosted network function associated with the twinned network function, third information indicative of the description files of the twinned network function.

53. The second network device of claim 52, wherein the twinned network function is one of a set of twinned network functions created based on the hosted network function, wherein the instructions, when executed by the processor circuitry, further cause the second network device to become operative to:
receive different sets of second information associated with different twinned network functions in the set of twinned network functions; and
determine the third information associated with one of a set of twinned network functions from the different sets of second information associated with different twinned network functions in the set of twinned network functions.

54. The second network device of claim 52, wherein the instructions, when executed by the processor circuitry, further cause the second network device to become operative to:
initiate the creation of a group of twinned network functions based on a group of hosted network function, the creation taking place within the enclave of the first network device;
send first information indicative of a change to description files associated with the group of twinned network functions; and
send, towards the group of hosted network functions associated with the group of twinned network functions, third information indicative of description files.

55. A method performed by a first network device in a computer network comprising the first network device and a second network device, the second network device possessing capabilities of a network manager and the first network device hosts a network function, wherein the method comprises:
creating an enclave, the enclave capable of receiving input information associated with the computer network and transmitting information to the second network device; and
determining, using the enclave, from an output of a twinned network function based on a hosted network function, after using the input information to run the twinned network function, if the output exposes a vulnerability or if the output indicates that the twinned network function has ceased to operate according to operational criteria set for the hosted network function, whereby either:
a change is made to description files associated with the twinned network function if the output exposes a vulnerability or if the twinned network function has ceased to operate according to operational criteria set for the hosted network function; or
information related to the description files is sent to the second network device to update the hosted network function.

56. A method performed by a second network device in a computer network comprising a first network device and the second network device, wherein the first network device is adapted to host a network function, wherein the method comprises:
requesting, of the first network device, creation of an enclave in the first network device;
initiating creation of a twinned network function within the enclave of the first network device, the twinned network function based on a hosted network function in the computer network;
sending first information indicative of a change to description files associated with the twinned network function;
receiving, from the first network device, second information related to the description files of the twinned network function; and
sending, towards the hosted network function associated with the twinned network function, third information indicative of the description files of the twinned network function.
